(19) United States
(12) Patent Application Publication
(10) Pub. No.: US 2025/0355595 A1
(43) Pub. Date: Nov. 20, 2025

(54) UNIFIED COMMAND TRANSMISSION FOR MANAGED MEMORY

(71) Applicant: Micron Technology, Inc., Boise, ID (US)

(72) Inventors: Binbin Huo, Taufkirchen (DE); Luca Porzio, Casalnuovo (NA) (IT)

(21) Appl. No.: 19/182,508

(22) Filed: Apr. 17, 2025

Related U.S. Application Data
(60) Provisional application No. 63/648,559, filed on May 16, 2024.

(51) Int. Cl. G06F 3/06; G06F 9/4401

(52) U.S. Cl. CPC G06F 3/0659; G06F 3/0604; G06F 3/0673; G06F 9/4401

(57) ABSTRACT

Methods, systems, and devices for unified command transmission for managed memory are described. A host system may be configured to transmit a unified command transmission including multiple boot commands of a same type to a memory system for performing a boot procedure of the memory system. A bootloader (e.g., system startup software) may support generating the unified command transmission, such that a host command manager may transmit the unified command transmission to the memory system. The memory system may receive the unified command transmission and perform the boot operations associated with the unified command transmission. In some cases, performing the boot operations may include sequentially performing each boot operation for a single system interrupt. The memory system may transmit information associated with the boot operations back to the host command manager in a message, and the host command manager may transmit an indication of the message to the bootloader.

### CROSS REFERENCE

The present Application for Patent claims priority to U.S. Patent Application No. 63/648,559 by Huo et al., entitled “UNIFIED COMMAND TRANSMISSION FOR MANAGED MEMORY,” filed May 16, 2024, which is assigned to the assignee hereof, and which is expressly incorporated by reference in its entirety herein.

### TECHNICAL FIELD

The following relates to one or more systems for memory, including unified command transmission for managed memory.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports unified command transmission for managed memory in accordance with examples as disclosed herein.

FIG. 2 shows an example of a system that supports unified command transmission for managed memory in accordance with examples as disclosed herein.

FIG. 3 shows an example of a process flow that supports unified command transmission for managed memory in accordance with examples as disclosed herein.

FIG. 4 shows an example of a command diagram that supports unified command transmission for managed memory in accordance with examples as disclosed herein.

FIG. 5 shows an example of a process flow that supports unified command transmission for managed memory in accordance with examples as disclosed herein.

FIG. 6 shows a block diagram of a host device that supports unified command transmission for managed memory in accordance with examples as disclosed herein.

FIG. 7 shows a block diagram of a memory device that supports unified command transmission for managed memory in accordance with examples as disclosed herein.

FIG. 8 shows a block diagram of a bootloader that supports unified command transmission for managed memory in accordance with examples as disclosed herein.

FIGS. 9 through 11 show flowcharts illustrating a method or methods that support unified command transmission for managed memory in accordance with examples as disclosed herein.

### DETAILED DESCRIPTION

In some systems, a host system may be configured to initiate a boot procedure (e.g., a power up procedure, an initialization procedure, system boot phase) for one or more memory devices of a memory system. The host system may include a host system controller including a bootloader (e.g., system startup software including a bootloader, a system kernel startup, an application/library loader operable during the system boot phase) and a host command manager configured to execute operations identified by the bootloader. That is, the bootloader may be software including instructions associated with performing the boot procedure at the one or more memory devices, and the host command manager may be configured to execute the instructions of the bootloader. For example, the bootloader may be configured to identify boot operations to be performed by the one or more memory devices and boot commands corresponding to the boot operations, and the host command manager may be configured to transmit the boot commands to the memory system based on accessing the bootloader (e.g., receiving the commands from the bootloader).

However, in some cases, the bootloader may not support multiple boot commands due to a queue depth of the bootloader being configured for single boot commands. In some such cases, the bootloader may identify and indicate each boot command associated with the boot procedure to the host command manager, such that the host command manager may transmit each boot command for the one or more memory devices to execute individually. For example, performing each boot operation (e.g., corresponding to each boot command) at the one or more memory devices may include receiving each boot command sequentially, performing each boot operation (e.g., accessing one or more memory arrays) sequentially, and transmitting information (e.g., indication of completion, data) associated with each boot operation to the host command manager sequentially. In some implementations, performing each boot operation may cause a system interrupt for completing and responding to each boot command, resulting in increased latency. Thus, transmitting each boot command individually, performing each boot operation individually, and responding to each boot command may be associated with relatively high latency, resulting in decreased bandwidth availability during performance of the boot procedure.

In accordance with examples as described herein, a system may support a unified command transmission. The unified command transmission may be used, for example, for performing a boot procedure of a memory system. According to various aspects, a host system may be configured to transmit a single command including multiple commands (e.g., associated with a boot procedure) of a same type to a memory system. For example, the unified command transmission may include multiple boot commands associated with a same type of boot operation. In some examples, the unified command transmission may include multiple memory device profile query commands (e.g., universal flash storage (UFS) query commands), multiple memory device provisioning commands (e.g., UFS interconnect commands (UICs)), or multiple memory device access commands (e.g., read commands, write commands). In some such examples, the memory device profile query commands and the memory device access commands may be associated with accessing one or more memory arrays of the memory system. In some other examples, the memory device profile query commands and the memory device provisioning commands may be associated with operations exclusive of accessing the one or more memory arrays.

In some cases, a bootloader may support generating the unified command transmission, such that a host command manager may transmit the unified command transmission to the one or more memory devices. For example, the bootloader may identify each boot command associated with the boot procedure and group boot commands associated with each type of boot operation. The bootloader may allocate a buffer and load boot commands of the same type into the buffer, then transmit an indication of the buffer (e.g., the unified command transmission) to the host command manager, whereby the host command manager may transmit the unified command transmission (e.g., a message including the boot commands) to the memory system. The memory system may receive the unified command transmission and perform the operations associated with the unified command transmission. In some cases, performing the operations may include sequentially performing each operation (e.g., accessing one or more memory devices, accessing memory system settings) without causing a system interrupt for each operation, such that the unified command transmission may be associated with a single system interrupt. The memory system may transmit information (e.g., indication of completion, data) associated with the operations back to the host command manager in one or more messages, and the host command manager may transmit an indication of information to the bootloader. Thus, performing the boot procedure based on the unified command transmission may be associated with decreased latency, resulting in relatively low latency and increased bandwidth availability during performance of the boot procedure.

In addition to applicability in memory systems as described herein, techniques for unified command transmission for managed memory be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by supporting communicating and executing a single boot procedure command including multiple subcommands associated with individual operations of the boot procedure, which may decrease processing or latency times for performing the boot procedure thereby improving user experience, among other benefits.

Features of the disclosure are illustrated and described in the context of systems, devices, and circuits. Features of the disclosure are further illustrated and described in the context of process flows, command diagrams, and flowcharts.

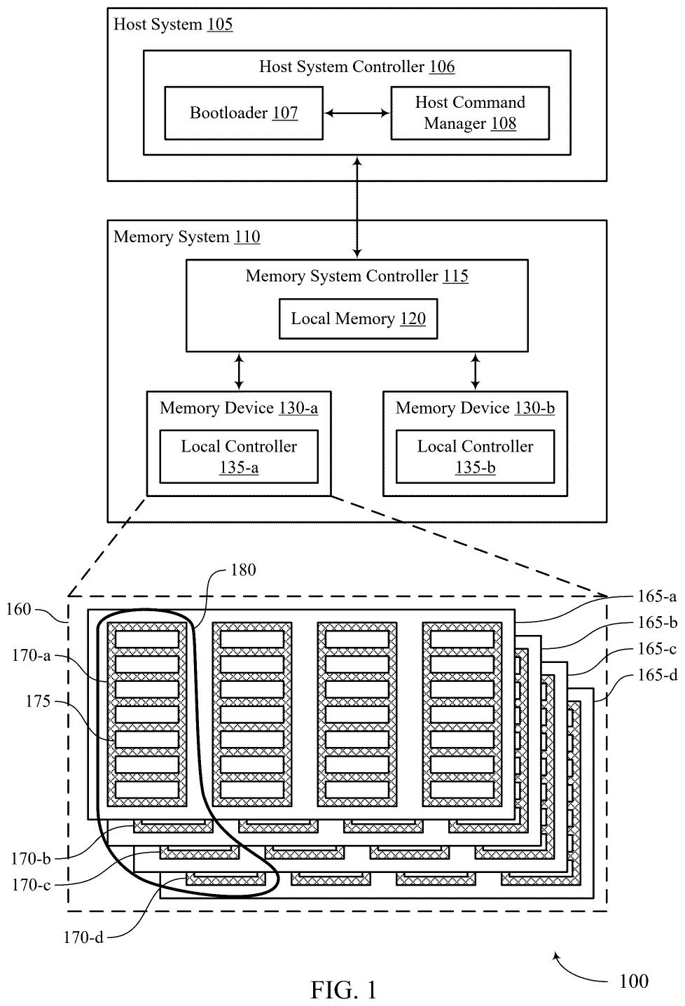

FIG. 1 shows an example of a system 100 that supports unified command transmission for managed memory in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a universal flash storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some systems, the host system 105 may be configured to initiate a boot procedure (e.g., a power up procedure, an initialization procedure, system boot phase) for the memory system 110. The host system controller 106 may include a bootloader 107 (e.g., system startup software including a bootloader, a system kernel startup, an application/library loader operable during the system boot phase) and a host command manager 108 configured to execute operations identified by the bootloader 107. For example, the bootloader 107 may be firmware (e.g., software) of the memory system controller 115 including instructions associated with performing the boot procedure at the memory devices 130, and the host command manager 108 may be configured to execute the instructions of the bootloader 107. In some cases, the bootloader 107 may be configured to identify boot operations to be performed by the memory devices 130 and boot commands corresponding to the boot operations. In some such examples, the host command manager 108 may be configured to execute the boot commands by transmitting the boot commands to the memory system 110 based on accessing the bootloader 107 (e.g., receiving the commands from the bootloader). In some implementations, the bootloader 107 may transmit information (e.g., commands, instructions, data) to the host command manager 108. However, in other implementations, the host command manager 108 may be configured to access the bootloader 107 and execute information stored in the bootloader 107.

In accordance with examples as described herein, the system 100 may support a unified command transmission for performing the boot procedure of the memory system 110. For instance, the host system 105 may be configured to transmit a single command including multiple boot commands of a same type to the memory system 110 (e.g., the memory system controller 115). For example, the unified command transmission may include multiple boot commands associated with a same type of boot operation, such that the unified command transmission may include multiple memory device profile query commands (e.g., UFS query commands), multiple memory device provisioning commands (e.g., UICs), or multiple memory device access commands (e.g., read commands, write commands). In some such examples, the memory device profile query commands and the memory device access commands may be associated with accessing one or more memory arrays (e.g., memory devices 130) of the memory system. In some other examples, the memory device profile query commands and the memory device provisioning commands may be associated with operations exclusive of accessing the one or more memory arrays.

In some cases, the bootloader 107 may support generating the unified command transmission, such that the host command manager 108 may transmit the unified command transmission to the memory system 110. For example, the bootloader 107 may identify each boot command associated with the boot procedure and group boot commands associated with each type of boot operation. The bootloader 107 may allocate a buffer and load boot commands of the same type into the buffer, then transmit an indication of the buffer (e.g., the unified command transmission) to the host command manager 108, whereby the host command manager 108 may transmit the unified command transmission (e.g., a message including the boot commands) to the memory system 110. The memory system 110 may receive the unified command transmission and perform the boot operations associated with the unified command transmission. In some cases, performing the boot operations may include sequentially performing each boot operation without causing a system interrupt for each boot operation, such that the unified command transmission may be associated with a single system interrupt (e.g., interrupt for the host command manager 108 upon the response by the memory system 110). The memory system 110 may transmit information (e.g., indication of completion, data) associated with the boot operations back to the host command manager 108 in one or more messages, and the host command manager 108 may transmit an indication of the information in the one or more messages to the bootloader 107. Thus, performing the boot procedure based on the unified command transmission may be associated with decreased latency, resulting in relatively low latency and increased bandwidth availability during performance of the boot procedure.

The system 100 may include any quantity of non-transitory computer readable media that support unified command transmission for managed memory. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

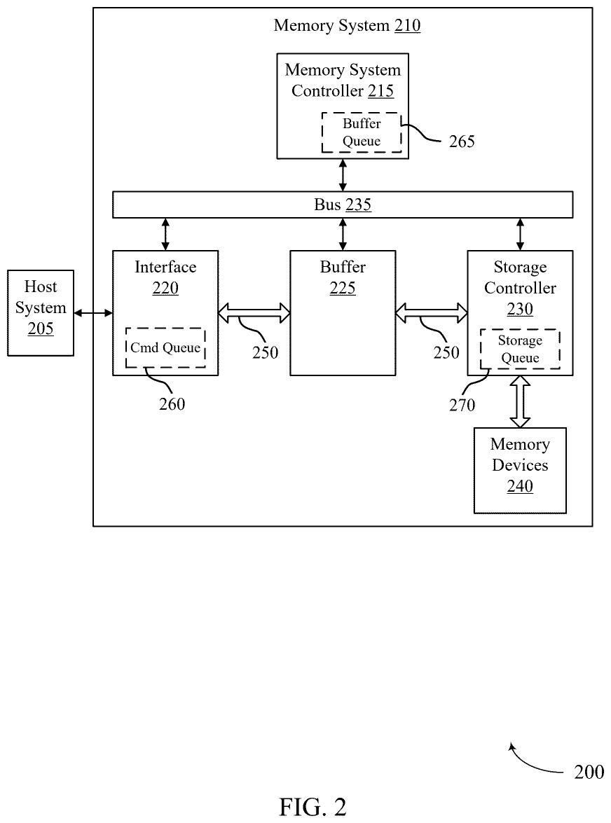

FIG. 2 shows an example of a system 200 that supports unified command transmission for managed memory in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

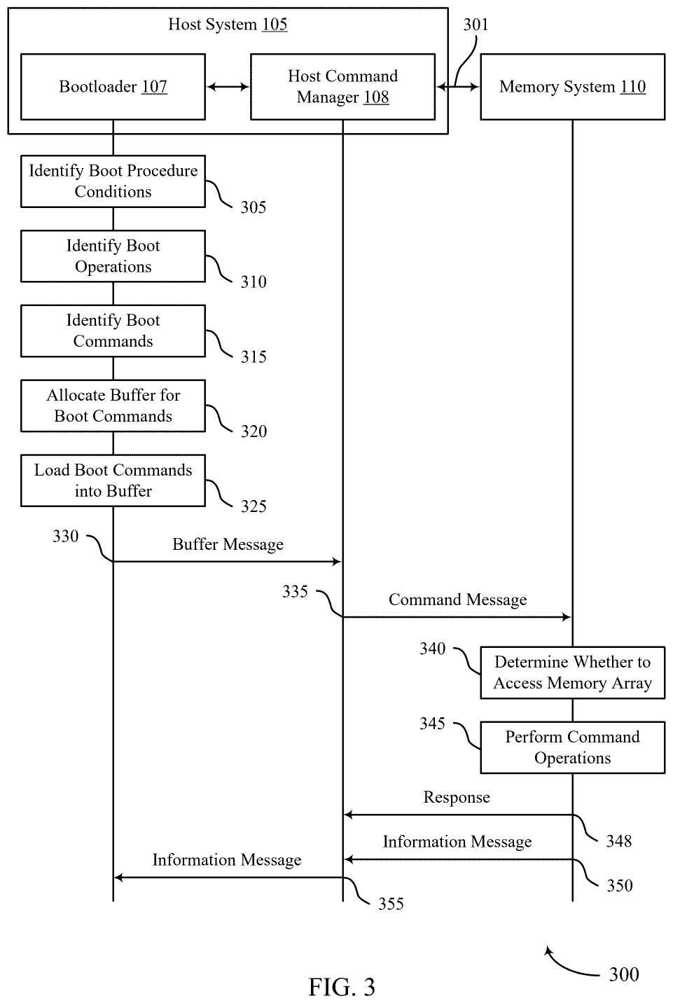

FIG. 3 shows an example of a process flow 300 that supports unified command transmission for managed memory in accordance with examples as disclosed herein. The process flow 300 may illustrate aspects or operations of a system, which may be an example of a system 100 or a system 200, as described with reference to FIGS. 1 and 2, respectively. For example, the process flow 300 may be implemented by a host system 105 or 205 and a memory system 110 or 210, as described with reference to FIG. 1 or 2. Further, some processes or operations of the process flow 300 may be implemented at a bootloader 107 (e.g., system startup software including a bootloader, a system kernel startup, an application/library loader operable during the system boot phase) and a host command manager 108, as described with reference to FIG. 1. The process flow 300 illustrates operations associated with performing a boot procedure for the system 100 based on a unified command transmission.

In the following description of the process flow 300, the methods, techniques, processes, and operations may be performed in different orders or at different times. Further, some operations may be left out of the process flow 300, or other operations may be added to the process flow 300. Aspect of the process flow 300 may be implemented by a memory system controller 115 or by the host system controller 106, which may include the bootloader 107 and the host command manager 108, as described with reference to FIG. 1. Additionally, or alternatively, aspects of the process flow 300 may be implemented as instructions stored in memory (e.g., firmware). For example, the instructions, if executed by a controller (e.g., a processor, a host system controller 106, the memory system controller 115, a local controller 135), may cause the controller to perform the operations of the process flow 300.

The process flow 300 may illustrate operations associated with performing a boot procedure for the memory system 110 based on transmitting a unified command transmission from the host system 105. The boot procedure may be a power-up procedure or an initiation procedure to cause the memory system 110 to change from an initial power level to an operating power level (e.g., associated with normal operations of the memory system 110), or an initial processing level to an operating processing level (e.g., associated with normal operations of the memory system 110). The memory system 110 may include one or more memory devices, which may be examples of a memory device 130 or 240, as described with reference to FIG. 1 or 2. Each memory device may include one or more memory arrays of memory cells. For example, each memory device may be a non-volatile memory device (e.g., a NAND memory device) including one or more non-volatile memory arrays (e.g., NAND memory arrays) of non-volatile memory cells (e.g., NAND memory cells). Additionally, the memory system 110 may include a memory system controller 115 configured to facilitate and perform operations on the one or more memory devices. In some cases, the memory system 110 may be an example of a UFS system, such that the memory system 110 may include a quantity of controllers, processors, and interfaces for facilitating and performing operations of the memory system 110. For example, the memory system controller 115 may include a UFS interface coupled with the host system 105. In some cases, the system may include a memory physical connection interface 301, such as a UFS interface, coupling the host system 105 and the memory system 110. The host system 105 and the memory system 110 may be configured to communicate via the memory physical connection interface 301 using a command descriptor, such as UFS protocol information units (UPIUs).

The host system 105 may include a host system controller 106 including the bootloader 107 and the host command manager 108. The bootloader 107 may be firmware (e.g., system startup software) including instructions which may be executed or transmitted to the host command manager 108. In some cases, the bootloader 107 may include one or more processors configured to modify the instructions stored at the bootloader 107. For example, the bootloader 107 may be or include a bootloader, a system kernel startup, or loading of application or system libraries. The host command manager 108 may be configured to execute operations based on commands received, or transmit and communicate commands on behalf of the host system 105. For example, the host command manager 108 may transmit commands indicated in the instructions of the bootloader 107 to the memory system controller 115. In some cases, (e.g., where the memory system 110 is a UFS system), the host command manager 108 may be coupled with the memory system controller 115 via the memory physical connection interface 301 and configured to communicate with the memory system controller 115 via the memory physical connection interface 301.

At 305, the bootloader 107 may identify conditions associated with initiating the boot procedure for the memory system 110. For example, the bootloader 107 may detect a power-up procedure or an initiation procedure associated with the memory system 110. In some implementations, the bootloader 107 may detect a change in an initial power level or an initial processing level of the memory system 110, and determine that the boot procedure is initiated. That is, the bootloader 107 may receive information from one or more sensors of the memory system 110, and may initiate the boot procedure based on a change in values indicated by the one or more sensors. For example, the bootloader 107 may receive an indication of the initial power level or the initial processing level, and after determining that a change in the initial power level or the initial processing level has satisfied a threshold, the bootloader 107 may determine the boot procedure is initiated. In some cases, the bootloader 107 may identify input received from a user of the host system 105, and determine the boot procedure is initiated.

At 310, the bootloader 107 may identify operations associated with performing the boot procedure for the memory system 110. In some cases, the bootloader 107 may store instructions including a list of operations to be performed at the memory system 110 during the boot procedure (e.g., to complete the boot procedure at the memory system 110). In some examples, the operations may include memory device profile query operations, such as UFS query operations. In some such examples, the memory device profile query operations may be associated with determining a characteristic of the memory system 110 (e.g., a memory device of the memory system 110), such as an operating parameter (e.g., a power level, a size of the memory system 110, an available storage space of the memory system 110). In some implementations, performing the memory device profile query operations may include accessing one or more memory arrays (e.g., or one or more registers) of the memory system 110. Whereas, in other implementations, performing the memory device profile query operations may not include accessing the one or more memory arrays.

In other examples, the operations may include memory device provisioning operations, such as UIC operations. In some such examples, the memory device provisioning operations may be associated with setting operating parameters (e.g., register information) or transmitting operational instructions to one or more controllers of the memory system 110. In some implementations, performing the memory device provisioning operations may not include accessing the one or more memory arrays. In some examples, the operations may include memory device access operations, such as read operations or write operations. In some such examples, the memory device access operations may be associated with accessing the one or more memory arrays. In some implementations when the memory device access operation is a read operation, performing the memory device access operation may include reading information from one or more memory cells of the one or more memory arrays and transmitting the information (e.g., to the host system 105, to another memory device). In some implementations when the memory device access operation is a write operation, performing the memory device access operation may include writing information to the one or more memory cells. The memory device access operation may include address information associated with accessing the memory system 110 and/or data to be accessed (e.g., read or written).

At 315, the bootloader 107 may identify commands associated with performing the boot procedure for the memory system 110. The commands may be associated with the operations identified at step 310 of the process flow 300. For example, the commands may be memory device profile query commands, such as UFS query commands, corresponding to the memory device profile query operations. Likewise, the commands may be memory device provisioning commands, such as UFS UIC commands, corresponding to the memory device provisioning operations. Further, the commands may be access commands, such as read commands or write commands, corresponding to the memory device access operations. In some examples, identifying the commands may include identifying the quantity of each type of command associated with performing the boot procedure. For example, identifying the commands may include identifying the quantity of memory device profile query commands, the quantity of memory device provisioning commands, and the quantity of access commands. In some examples, identifying the commands may include identifying the size of each type of command, such that the size may be indicative of the size of each command of the quantity of commands for each type of command.

At 320, the bootloader 107 may allocate a buffer for the commands identified at step 315 of the process flow 300. That is, the bootloader 107 may allocate a buffer for the boot commands corresponding to the operations associated with performing the boot procedure for the memory system 110. The buffer may be a packet associated with the commands. In some cases, the buffer may be a physical storage space of the host system 105 (e.g., a local memory). In other cases, the buffer may be a command descriptor, such as a UFS UPIU, to be transmitted from the host system 105 to the memory system 110. In some examples, the buffer may be allocated based on the quantity of commands identified at step 315 of the process flow 300. For example, the bootloader 107 may identify a quantity of commands, identify a size corresponding to the quantity of commands, and allocate the size of the buffer based on the size corresponding to the quantity of commands.

In some cases, the bootloader 107 may select the type of command associated with the buffer. That is, the buffer may be configured to store a single type of command, such that after identifying the commands associated with performing the boot procedure, the bootloader 107 may select the type of command for the buffer. For example, the bootloader 107 may select the memory device profile query commands for the buffer, and the bootloader 107 may allocate the buffer based on selecting the memory device profile query commands. That is, the bootloader 107 may identifying the quantity of memory device profile query commands and the size associated with the quantity, then the bootloader 107 may allocate the buffer (e.g., the size of the buffer) based on the size. In some cases, the bootloader 107 may allocate multiple buffers, such that each type of command is allocated a specific buffer.

At 325, the bootloader 107 may load the buffer with the commands associated with performing the boot procedure. After allocating the buffer based on the commands, the bootloader 107 may load the commands into the buffer. In cases where the buffer is configured to store a single type of command, the bootloader 107 may load the commands selected for the buffer during allocation for loading into the buffer. For example, when the buffer is allocated for storing the memory device profile query commands, the bootloader 107 may load the memory device profile query commands into the buffer at 325. In some cases, loading the buffer may generate a packet associated with the buffer. That is, the buffer may be a message including each of the commands loaded into the buffer. In some cases, loading the buffer may include generating a command descriptor, such as a UPIU, including fields indicating the type of commands and the commands associated with the buffer.

At 330, the bootloader 107 may transmit an indication of the buffer to the host command manager 108 based on loading the buffer. For example, the bootloader 107 may transmit the buffer to the host command manager 108 as a message, where the message includes the commands loaded into the buffer. In other examples, the bootloader 107 may transmit an indication that the buffer has been loaded to the host command manager 108. In some cases, transmitting the indication of the buffer to the host command manager 108 may include the host command manager 108 accessing the buffer. For example, the host command manager 108 may access the buffer stored by the bootloader 107. In some such examples, the host command manager 108 may access the commands loaded into the buffer. In other examples, the host command manager 108 may access the buffer received in the message, which may include accessing the commands included in the message (e.g., based on loading the commands into the buffer).

At 335, the host command manager 108 may transmit a command message to the memory system 110 via the memory physical connection interface 301. In some cases, the memory system 110 may receive the command message via the memory system controller 115 (e.g., via the UFS interface). The command message may be a unified command transmission, and may include each of the commands transmitted as part of the buffer. That is, each unified command transmission may include a single type of command based on the buffer being associated with a single type of command. For example, the unified command transmission may include the memory device profile query commands based on the memory device profile query commands being loaded into the buffer. In some cases, unified command transmission may be transmitted as a command descriptor (e.g., a UPIU) to the memory system 110 via the memory physical connection interface 301. That is, the unified command transmission may include a quantity of fields indicating the type of commands and the commands associated with the buffer.

At 340, the memory system 110 may determine whether to access the one or more memory arrays of the memory system 110 based on the command message. For example, some memory device profile query commands and the access commands may be associated with accessing the one or more memory arrays, whereas some memory device profile query commands and the memory device provisioning commands may not be associated with accessing the one or more memory arrays. The memory system 110 may determine the type of command associated with the command message, and then determine whether the type of command is associated with accessing the one or more memory arrays. For example, the memory system 110 may identify the type of command associated with the command message is memory device profile query commands, and the memory system 110 may determine whether to access the memory arrays based on details of the memory device profile query commands. In some cases, determining the type of command may include identifying the type of command from a field of the command descriptor (e.g., UFS UPIU).

At 345, the memory system 110 may perform the operations associated with the commands received as part of the command message. That is, if the command message indicated a quantity of memory device profile query commands, performing the command operations may include performing a quantity of memory device profile query operations. Likewise, if the command message indicated a quantity of memory device provisioning commands, performing the command operations may include performing a quantity of memory device provisioning operations. Further, if the command message indicated a quantity of memory device access commands, performing the command operations may include performing a quantity of memory device access operations. In some cases, performing the command operations may include altering the power level of the memory system 110 from the initial power level to the operating power level (e.g., enabling one or more power supplies), or altering the processing level of the memory system 110 from the initial processing level to the operating processing level. In some cases, performing the operations associated with the boot procedure may be facilitated by the memory system controller 115, or local controllers of the memory devices. In some cases, performing the operations associated with the boot procedure may be facilitated by the UFS interface in the memory system controller 115. In some cases, the memory system 110 may determine to access the one or more memory arrays at step 340 of the process flow 300 based on the command message, thus performing the command operations may include accessing the one or more memory arrays. In other cases, the memory system 110 may determine not to access the one or more memory arrays at step 340 of the process flow 300 based on the command message, thus performing the command operations may not include accessing the one or more memory arrays.

At 348, the memory system 110 may transmit a response to the unified command transmission. The response may be, for example, a UFS ready to transfer the command descriptor indicating that the memory system 110 has information to provide to the host system 105 as a result of the command operations of the unified command transmission. The response transmitted at 348 may be associated with an interrupt (e.g., a single interrupt associated with the unified command transmission) for the host command manager 108 (e.g., may trigger an interrupt for host command manager 108). For example, the memory system 110 may perform all commands of the unified command transmission and indicate to the host system 105 using the response at 348 that the commands of the unified command transmission are complete and the information associated with the commands is ready for transfer.

At 350, the memory system 110 may transmit information associated with performing the command operations to the host command manager 108. In some cases, the information may be transmitted as a single message including information associated with each operation (e.g., each command) of the command operations. In other cases, the information may be transmitted as a quantity of messages corresponding to the quantity of operations performed during the command operations, where each message includes information associated with the respective operation or region of memory addresses. In some examples, the information may be indications associated with completing the operations of the command operations, such that each indication may be representative of completing a respective operation of the command operations. In other examples, the information may be information associated with the commands. For example, the memory device profile query commands may request information about a characteristic of the memory system 110 (e.g., a memory device of the memory system 110), such as an operating parameter (e.g., a power level, a size of the memory system 110, an available storage space of the memory system 110), thus the information transmitted may correspond to a response to such commands. In some examples, the information may be data associated with the commands. For example, the memory device access commands (e.g., read commands) may request data from the memory system 110, thus the information transmitted may be data associated with such commands. In some aspects, the information transferred at 350 may use direct memory access (DMA). For example, the host system 105 (e.g., host command manager 108) may allocate a memory region for transfer of the information. In some cases, the host command manager 108 may specify DMA transfer parameters in memory descriptors (e.g., source (SRC) or destination (DST) descriptors). In some cases, the host command manager 108 may use a scatter gather DMA mode where data transfer from one non-contiguous block of memory may be performed using a series of smaller contiguous block transfers, where at least a subset of the series of smaller contiguous block transfers may be included in a single unified command transmission.

At 355, the host command manager 108 may transmit information associated with performing the command operations to the bootloader 107. In some cases, the information may be transmitted as a single message including information associated with each operation (e.g., each command) of the boot procedure. In other cases, the information may be transmitted as a quantity of messages corresponding to the quantity of operations performed during the boot procedure, where each message includes information associated with the respective operation. In some examples, the information may be indications associated with completing the operations of the boot procedure, such that each indication may be representative of completing a respective operation of the boot procedure. In other examples, the information may be information associated with the commands. In some examples, the information may be data associated with the commands.

In some cases, the bootloader 107 may use the information to verify completion of the boot procedure or to initiate other parts of the boot procedure. For example, the operations associated with the information may be associated with a type of command indicated by the command message, however may not be indicative of all the operations included in the boot procedure. Thus, the bootloader 107 may reinitiate the boot procedure for the next type of command. For example, the process flow 300 may restart at step 310 for the remaining operations of the boot procedure. In some cases, the process flow 300 may restart a quantity of times (e.g., iterations) until the boot procedure is completed.

Implementing the unified command transmission within the process flow 300 may support increased latency and processing availability during performing the boot procedure. For example, implementing the unified command transmission may enable a single system interrupt for a quantity of commands and operations of the boot procedure, thereby reducing latency otherwise associated with a quantity of system interrupts for the quantity of commands and operations. Likewise, the single system interrupt may provide additional processing availability for performing other operations during the boot procedure.

It should be understood that the boot procedure shown in FIG. 3 is one example of use of the unified command transmission of 335. The unified command transmission at 335 and corresponding operations performed at 345 may be used for operations outside of the described boot procedure for sending a single unified command to correspond to execution of multiple commands at memory system 110, where the multiple commands are associated with a single response (e.g., response message sent at 348).

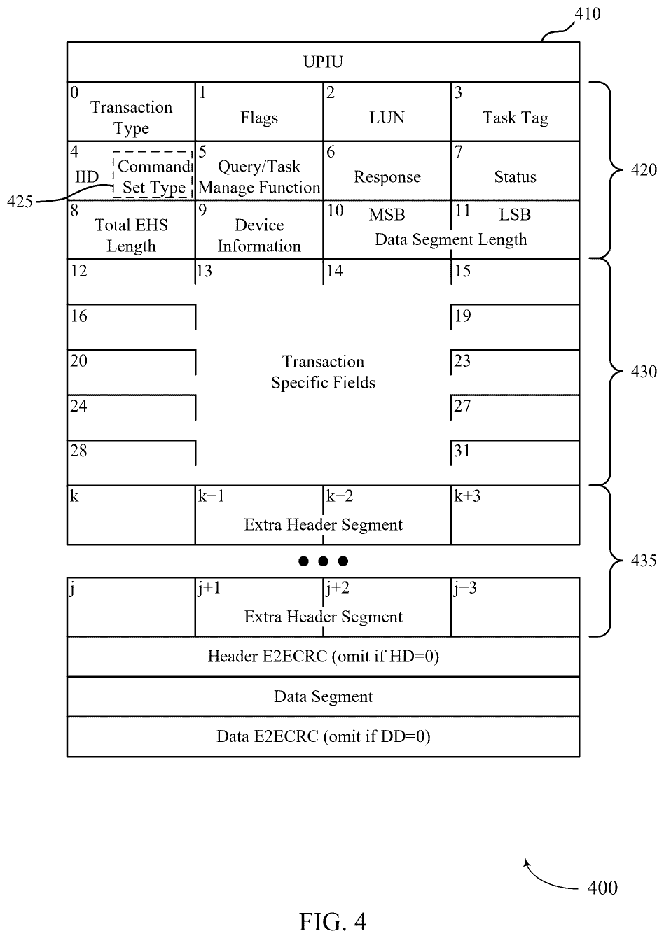

FIG. 4 shows an example of a command diagram 400 that supports unified command transmission for managed memory in accordance with examples as disclosed herein. The command diagram 400 may illustrate aspects or operations implemented by a system, which may be an example of a system 100 or a system 200, as described with reference to FIGS. 1 and 2, respectively. For example, the command diagram 400 may be implemented by a host system 105 or 205 and a memory system 110 or 210, as described with reference to FIG. 1 or 2. Likewise, the command diagram 400 may illustrate a command message implemented within the process flow 300, as described with reference to FIG. 3. The command diagram 400 may be an example of a command descriptor for a unified command transmission, in which a single message transmitted between the host system 105 and the memory system 110 may include a quantity of commands corresponding to operations associated with performing a boot procedure of the memory system 110.

The command diagram 400 illustrates the unified command transmission, which may be transmitted as a command descriptor (e.g., UFS UPIU) 410 via a memory physical connection interface 301 (e.g., UFS interface) between the host system 105 and the memory system 110, as described with reference to FIG. 3. In some examples, the command diagram 400 may be an example of a buffer message transmitted between a bootloader 107 (e.g., system startup software) and a host command manager 108, implemented within a host system controller 106, as described with reference to FIG. 1. In some such examples, the buffer message may be generated by the bootloader 107. In other examples, the command diagram 400 may be an example of a command message transmitted between the host command manager 108 and the memory system 110. In some such examples, the command message may be generated by the bootloader 107 and initially transmitted as the buffer message to the host command manager 108, or the command message may be generated by the host command manager 108 based on receiving the buffer message from the bootloader 107.

The command diagram 400 illustrates the command descriptor 410 including a quantity of fields, each associated with storing one or more bits. According to various aspects, the command descriptor may include a quantity of fields identifying aspects or characteristics of the unified command transmission. For example, the command descriptor 410 may include a unified command transmission header 420, transaction specific fields 430, and extended command field 435, each associated with one or more fields. The unified command transmission header 420 may include a field indicating whether the command descriptor includes a unified command transmission. The transaction specific fields 430 may specify which kinds of commands are in the extended command field 435. The extended command field 435 may include a command list. In one example, the command descriptor may correspond to a UFS UPIU, where the UPIU may include fields associated with the unified command transmission header 420, including fields identifying a transaction type of the UPIU, flags of the UPIU, a logical unit number (LUN) of the UPIU, a query function of the UPIU, a task management function of the UPIU, a status of the UPIU, device information, extra head segment length of the UPIU, data segment length of the UPIU. Likewise, the UPIU may include fields associated with the extended command field 435, including extra header segments, header end-to-end cyclic redundancy check (E2ECRC) bits, data segments of the UPIU, and data E2ECRC bits. In some such examples, the fields may include bits indicating substantive information associated with the respective field, or the fields may include bits indicating whether to support operations associated with the respective field.

The command diagram 400 illustrates the UPIU including a field indicating a command set type 425. The field indicating the command set type may be a field including an initiator identifier (IID) and a subspace otherwise reserved, in which the command set type 425 may be included in the subspace. For example, the field “4” may include the IID and the command set type 425. The command set type 425 may indicate the type of commands associated with the unified command transmission. That is, each UPIU may be associated with including a quantity of commands of the same type of command, and the command set type 425 may be indicative of such same type of command. In some examples, the command set type 425 may indicate the quantity of commands are memory device profile query commands, memory device provisioning commands, or memory device access commands.

The command diagram 400 illustrates the command descriptor 410 including a quantity of fields indicating each of the quantity of commands associated with the unified command transmission. For example, the command descriptor may include transaction specific fields 430 (e.g., fields 12-31), where each transaction specific field may identify a command of the unified command transmission. In some cases, the transaction specific fields 430 may be configured to store headers indicative of the quantity of commands. For example, each transaction specific field may store a header associated with a respective command of the quantity of commands. In some cases, the transaction specific fields may function as a list for the quantity of commands.

The command diagram 400 illustrates the command descriptor including a quantity of fields dedicated for storing each of the quantity of commands associated with the unified command transmission. For example, the command descriptor may include extra header segments as part of the extended command field 435 (e.g., fields k, k+1, k+2, k+3, where k is a whole number; fields j, j+1, j+2, j+3, where j is a whole number) each configured to store a respective command of the quantity of commands. In cases where the transaction specific field function as a list for the quantity of commands, the extra header segments may function as storing the commands themselves. For example, the extra header segments may store details associated with executing each of the commands (e.g., LBA address, block length).

Implementing the unified command transmission with the quantity of commands associated with the boot procedure may support increased latency and processing availability during performing the boot procedure. For example, implementing the unified command transmission may enable a single system interrupt for a quantity of commands and operations of the boot procedure, thereby reducing latency otherwise associated with a quantity of system interrupts for the quantity of commands and operations. Likewise, the single system interrupt may provide additional processing availability for performing other operations during the boot procedure. Additionally or alternatively, the unified command transmission may be used for enabling multiple commands to be conveyed within a single unified command transmission (e.g., a single UPIU) for commands to be executed outside of a boot procedure.

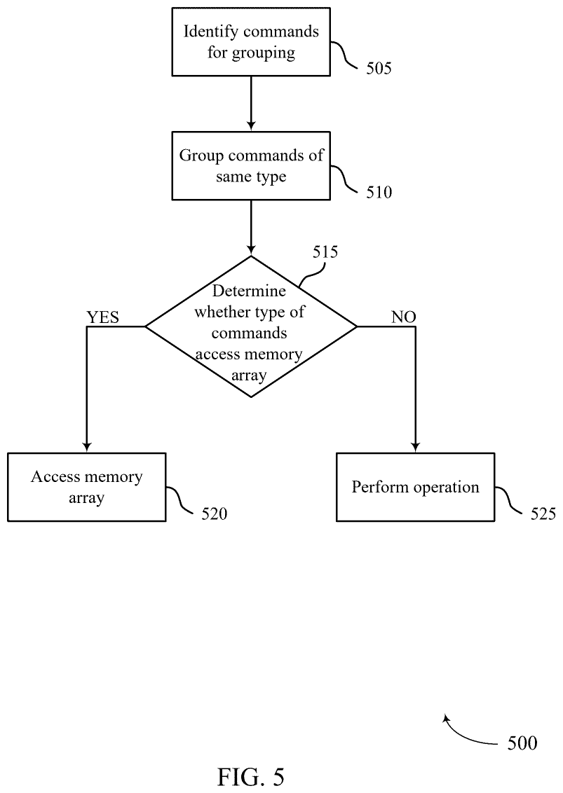

FIG. 5 shows an example of a process flow 500 that supports unified command transmission for managed memory in accordance with examples as disclosed herein. The process flow 500 may illustrate aspects or operations of a system, which may be an example of a system 100 or a system 200, as described with reference to FIGS. 1 and 2, respectively. For example, the process flow 500 may be implemented by a host system 105 or 205 and a memory system 110 or 210, as described with reference to FIG. 1. Further, some processes or operations of the process flow 500 may be implemented by a host system controller 106 including a bootloader 107 (e.g., system startup software) and a host command manager 108, as described with reference to FIG. 1. The process flow 500 illustrates operations associated with performing a boot procedure for the system 100 based on a unified command transmission.

In the following description of the process flow 500, the methods, techniques, processes, and operations may be performed in different orders or at different times. Further, some operations may be left out of the process flow 500, or other operations may be added to the process flow 500. Additionally, or alternatively, aspects of the process flow 500 may be implemented as instructions stored in memory (e.g., firmware). For example, the instructions, if executed by a controller (e.g., a processor, a host system controller 106, the memory system controller 115, a local controller 135), may cause the controller to perform the operations of the process flow 500.

At 505, the host system controller 106 may identify commands associated with performing the boot procedure for the memory system 110. For example, the bootloader 107 may identify operations associated with performing the boot procedure and commands corresponding to the identified operations. In some such examples, the bootloader 107 may identify a type of each command identified. That is, for each command, the bootloader 107 may determine whether the command is a memory device profile query command (e.g., a UFS query command), a memory device provisioning command (e.g., a UIC command), or a memory device access command (e.g., a read command, a write command).

At 510, the host system controller 106 may group commands of the same type. For example, after identifying the type of each command, the bootloader 107 may determine a quantity of commands for each type of command. That is, the bootloader 107 may determine the quantity of memory device profile query commands, the quantity of memory device provisioning commands, and a quantity of memory device access commands. After determining the quantity of each type of command, the bootloader 107 may group the commands such that each command is grouped with other commands of the same type of command. For example, the quantity of memory device profile query commands may be grouped, the quantity of memory device provisioning commands may be grouped, and the quantity of memory device access commands may be grouped.

After grouping the commands into groups of the same type, the host system controller 106 may assemble one or more unified command transmissions. For example, the bootloader 107 may assemble each group of commands into a respective unified command transmission, which may include the commands associated with the group. In some cases, assembling the one or more unified command transmissions may include allocating one or more buffers, where each buffer is associated with a respective group. In some such cases, assembling the one or more unified command transmissions may include loading each of the one or more buffers with the respective group of commands. In other cases, host command manager 108 may access the buffer (e.g., receive the buffer from the bootloader 107) and assemble the one or more unified command transmissions. For example, the host command manager 108 may generate a UPIU indicating each unified command transmission and transmit the UPIU to the memory system 110 via a memory physical connection interface 301, as described with reference to FIG. 3.

At 515, the memory system 110 may determine whether to access one or more memory arrays of the memory system 110 based on the one or more unified command transmissions. That is, the memory system controller 115 may receive the one or more unified command transmissions, and the memory system controller 115 may determine the type of commands associated with each unified command transmission. After identifying the type of commands included in each unified command transmission, the memory system controller 115 may determine whether the type of commands are associated with accessing the one or more memory arrays. For example, the memory device profile query commands may or may not be associated with accessing the one or more memory arrays. In some such examples, the memory system controller 115 may identify other details associated with the memory device profile query commands to determine whether the unified command transmission indicates to access the one or more memory arrays. In other examples, the memory device provisioning commands may be associated with not accessing the one or more memory arrays. In some examples, the memory device access commands may be associated with accessing the one or more memory arrays. In some cases, the memory system 110 may determine the type of commands corresponding to the one or more unified command transmissions are associated with accessing the one or more memory arrays, and the process flow 500 may continue to step 520. However, in other cases, the memory system 110 may determine the type of commands corresponding to the one or more unified command transmissions are associated with not accessing the one or more memory arrays, and the process flow 500 may continue to step 525.

At 520, the memory system 110 may access the one or more memory arrays as part of performing the boot procedure. That is, the memory system 110 may access the one or more memory arrays to access data in the one or more memory arrays. For example, the memory system 110 may identify the unified command transmission is associated with a quantity of write commands, and the memory system 110 may write data associated with the quantity of write commands to the one or more memory arrays. In other examples, the memory system 110 may identify the unified command transmission is associated with a quantity of read commands, and the memory system 110 may read data associated with the quantity of read commands from the one or more memory arrays. In some examples, the memory system 110 may identify the unified command transmission is associated with a quantity of memory device profile query commands, such as UFS query commands requesting an indication of available storage capacity of the one or more memory arrays, and the memory system 110 may access the one or more memory arrays to determine the available storage capacity of the one or more memory arrays. In some cases, accessing the one or more memory arrays may include performing direct memory access (DMA). In some such cases, accessing the one or more memory arrays may include identifying mapping information associated with the one or more memory arrays.

At 525, the memory system 110 may not access the one or more memory arrays as part of performing the boot procedure. That is, the memory system 110 may perform operations associated with the boot procedure without accessing the one or more memory arrays. For example, the memory system 110 may identify the unified command transmission is associated with a quantity of memory device profile query commands, such as UFS query commands requesting an indication of a power level of the memory system 110, and the memory system 110 may not access the one or more memory arrays to identify the power level. In some such examples, the memory system 110 may identify the power level based on detecting information from one or more sensors at the memory system 110. In other examples, the memory system 110 may identify the unified command transmission is associated with a quantity of memory device provisioning commands, such as UIC commands, and the memory system 110 may perform one or more UIC operations without accessing the one or more memory arrays.

In some cases, the memory system 110 may transmit information back to the host system 105 after accessing or not accessing the one or more memory arrays. For example, the memory system 110 may transmit information including data or indications of completion back to the host system 105, where the data or indications correspond to each command associated with the unified command transmission. In some examples, the memory system 110 may transmit the information as a single message to the host system 105.

Implementing the unified command transmission within the process flow 500 may support increased latency and processing availability during performing the boot procedure. For example, implementing the unified command transmission may enable a single system interrupt for a quantity of commands and operations of the boot procedure, thereby reducing latency otherwise associated with a quantity of system interrupts for the quantity of commands and operations. Likewise, the single system interrupt may provide additional processing availability for performing other operations during the boot procedure.

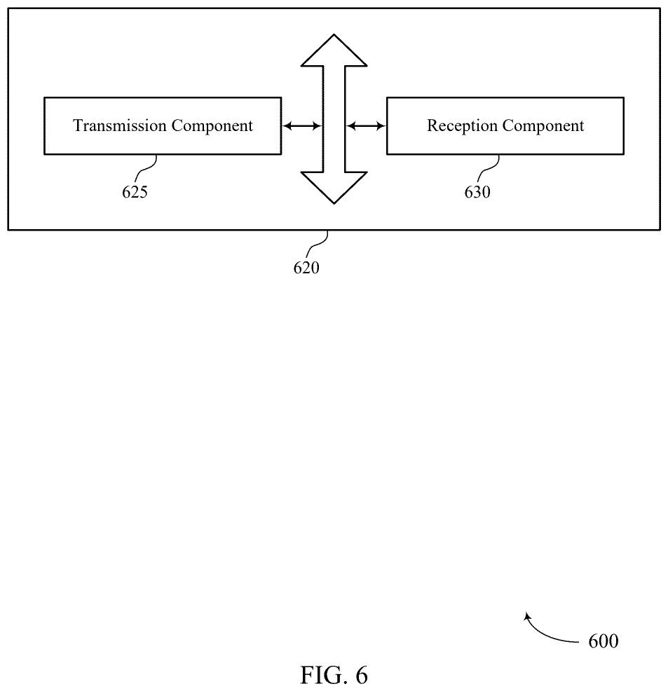

FIG. 6 shows a block diagram 600 of a host device 620 that supports unified command transmission for managed memory in accordance with examples as disclosed herein. The host device 620 may be an example of aspects of a host device as described with reference to FIGS. 1 through 5. The host device 620, or various components thereof, may be an example of means for performing various aspects of unified command transmission for managed memory as described herein. For example, the host device 620 may include a transmission component 625 a reception component 630, or any combination thereof. Each of these components, or components of subcomponents thereof (e.g., one or more processors, one or more memories), may communicate, directly or indirectly, with one another (e.g., via one or more buses).

The transmission component 625 may be configured as or otherwise support a means for transmitting, to a memory device, a first message including a plurality of commands, where the first message includes a field indicating a type of the plurality of commands, and where each command of the plurality of commands is a memory device profile query command or a memory device provisioning command. The reception component 630 may be configured as or otherwise support a means for receiving, from the memory device, one or more second messages including information for each command of the plurality of commands based at least in part on transmitting the first message.

In some examples, the reception component 630 may be configured as or otherwise support a means for receiving, from a boot loader, an indicator of a buffer including the plurality of commands, where transmitting the first message to the memory device is based at least in part on receiving the indicator from the boot loader.

In some examples, the transmission component 625 may be configured as or otherwise support a means for providing the information to a boot loader based at least in part on receiving the one or more second messages from the memory device.

In some examples, the first message indicates for the memory device to access a respective portion of one or more memory arrays of the memory device for each command of the plurality of commands.

In some examples, the first message is a single memory device command. In some examples, the plurality of commands are included in an extra header segment portion of the single memory device command.

In some examples, the transmission component 625 may be configured as or otherwise support a means for transmitting, to the memory device, a third message including a plurality of second commands, where the third message includes the field indicating the type of the plurality of second commands, where each second command of the plurality of second commands is a read command or a write command. In some examples, the reception component 630 may be configured as or otherwise support a means for receiving, from the memory device, one or more fourth messages including data for each second command of the plurality of second commands based at least in part on transmitting the third message.

In some examples, transmitting the first message including the plurality of commands is based at least in part on initiating a boot procedure of the memory device.

In some examples, the information associated with each command includes query response information or interconnect response information.

In some examples, the described functionality of the host device 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host device 620, or various components thereof, may be implemented at least in part by instructions (e.g., stored in memory, non-transitory computer-readable medium) executable by such at least one processor.

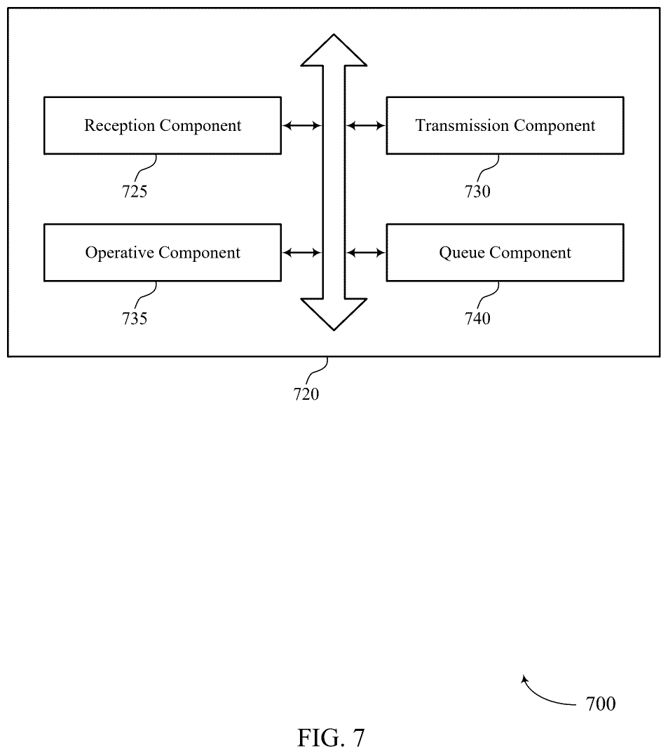

FIG. 7 shows a block diagram 700 of a memory device 720 that supports unified command transmission for managed memory in accordance with examples as disclosed herein. The memory device 720 may be an example of aspects of a memory device as described with reference to FIGS. 1 through 5. The memory device 720, or various components thereof, may be an example of means for performing various aspects of unified command transmission for managed memory as described herein. For example, the memory device 720 may include a reception component 725, a transmission component 730, an operative component 735, a queue component 740, or any combination thereof. Each of these components, or components of subcomponents thereof (e.g., one or more processors, one or more memories), may communicate, directly or indirectly, with one another (e.g., via one or more buses).

The reception component 725 may be configured as or otherwise support a means for receiving, from a host device, a first message including a plurality of commands, where the first message includes a field indicating a type of the plurality of commands, and where each command of the plurality of commands is a memory device profile query command or a memory device provisioning command. The transmission component 730 may be configured as or otherwise support a means for transmitting, to the host device, one or more second messages including information associated with each command of the plurality of commands based at least in part on receiving the first message.

In some examples, the operative component 735 may be configured as or otherwise support a means for performing a plurality of operations corresponding to the plurality of commands based at least in part on receiving the first message, where transmitting the one or more second messages is based at least in part on performing the plurality of operations.

In some examples, the information associated with each command includes query response information or interconnect response information.

In some examples, to support performing the plurality of operations, the queue component 740 may be configured as or otherwise support a means for placing, based at least in part on receiving the first message, a single bundled command corresponding to the plurality of commands into a command queue for execution, the single bundled command corresponding to a single response to the host device.

In some examples, the operative component 735 may be configured as or otherwise support a means for accessing a respective portion of one or more memory arrays of the memory device for each command of the plurality of commands, where transmitting the one or more second messages is based at least in part on accessing the respective portion of the one or more memory arrays for each command of the plurality of commands.

In some examples, the information associated with each command includes data associated with accessing the respective portion of the one or more memory arrays for the respective command of the plurality of commands.

In some examples, the first message is a single memory device command. In some examples, the plurality of commands are included in an extra header segment portion of the single memory device command.

In some examples, the reception component 725 may be configured as or otherwise support a means for receiving, from the host device, a third message including a plurality of second commands, where the third message includes the field indicating the type of the plurality of second commands, and where each second command of the plurality of second commands is a read command or a write command. In some examples, the transmission component 730 may be configured as or otherwise support a means for transmitting, to the host device, one or more fourth messages including data associated with each second command of the plurality of second commands based at least in part on receiving the third message.

In some examples, the operative component 735 may be configured as or otherwise support a means for accessing a respective portion of one or more memory arrays of the memory device for each second command of the plurality of second commands, where transmitting the one or more fourth messages is based at least in part on accessing the respective portion of the one or more memory arrays for each second command of the plurality of second commands.

In some examples, receiving the first message including the plurality of commands is based at least in part on initiating a boot procedure of the memory device.

In some examples, the described functionality of the memory device 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory device 720, or various components thereof, may be implemented at least in part by instructions (e.g., stored in memory, non-transitory computer-readable medium) executable by such at least one processor.

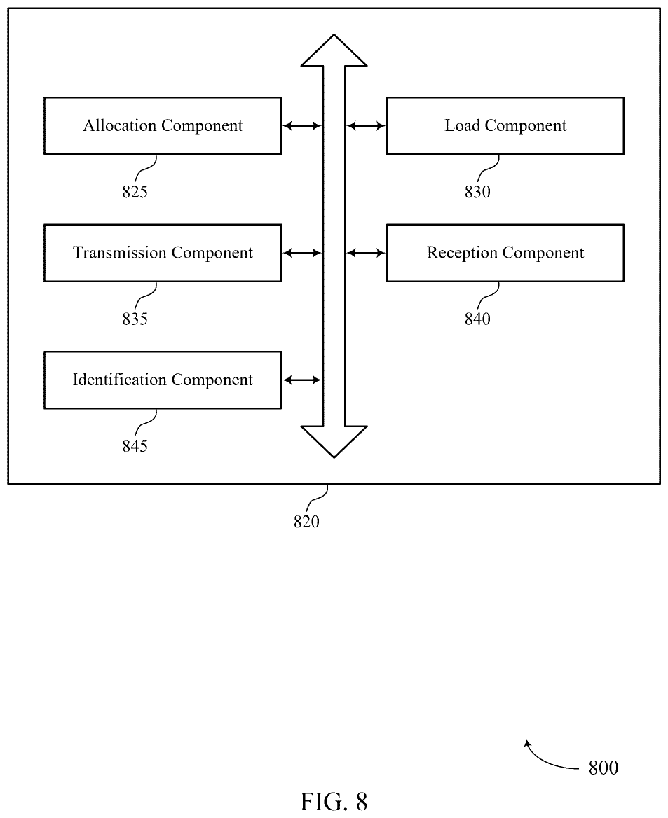

FIG. 8 shows a block diagram 800 of a bootloader 820 that supports unified command transmission for managed memory in accordance with examples as disclosed herein. The bootloader 820 may be an example of aspects of a bootloader as described with reference to FIGS. 1 through 5. The bootloader 820, or various components thereof, may be an example of means for performing various aspects of unified command transmission for managed memory as described herein. For example, the bootloader 820 may be system startup software associated with performing operations for a system boot phase (e.g., a system startup), and may include components such as a bootloader, a system kernel startup, and application or system libraries loading. The bootloader 820 may include an allocation component 825, a load component 830, a transmission component 835, a reception component 840, an identification component 845, or any combination thereof. Each of these components, or components of subcomponents thereof (e.g., one or more processors, one or more memories), may communicate, directly or indirectly, with one another (e.g., via one or more buses).

The allocation component 825 may be configured as or otherwise support a means for allocating a buffer for a plurality of commands, where each command of the plurality of commands includes a same type of command. The load component 830 may be configured as or otherwise support a means for loading the plurality of commands into the buffer. The transmission component 835 may be configured as or otherwise support a means for providing, to a host command manager, a message including an indication of the buffer based at least in part on loading the plurality of commands into the buffer. The reception component 840 may be configured as or otherwise support a means for obtaining, from the host command manager, information associated with each of the plurality of commands.

In some examples, the identification component 845 may be configured as or otherwise support a means for identifying a plurality of operations associated with a boot procedure, where the plurality of commands correspond to the plurality of operations, where allocating the buffer for the plurality of commands is based at least in part on identifying the plurality of operations.

In some examples, the identification component 845 may be configured as or otherwise support a means for identifying a power level change associated with a boot procedure, where allocating the buffer for the plurality of commands is based at least in part on identifying the power level change associated with the boot procedure.

In some examples, the identification component 845 may be configured as or otherwise support a means for identifying a quantity of commands of the plurality of commands. In some examples, the identification component 845 may be configured as or otherwise support a means for identifying a size of the buffer based at least in part on identifying the quantity of commands, where allocating the buffer for the plurality of commands is based at least in part on identifying the size of the buffer.

In some examples, the type of command includes a memory device profile query command or a memory device provisioning command.

In some examples, the type of command includes a read command or a write command.

In some examples, the message includes a field indicating the type of command of the plurality of commands.

In some examples, the described functionality of the bootloader 820, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the bootloader 820, or various components thereof, may be implemented at least in part by instructions (e.g., stored in memory, non-transitory computer-readable medium) executable by such at least one processor.

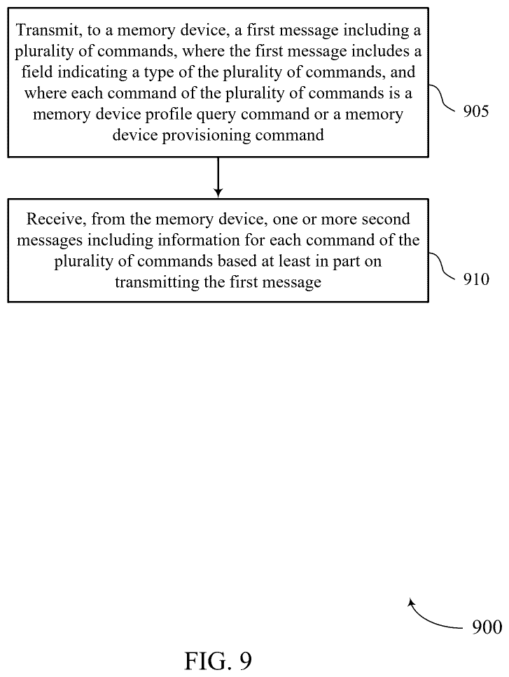

FIG. 9 shows a flowchart illustrating a method 900 that supports unified command transmission for managed memory in accordance with examples as disclosed herein. The operations of method 900 may be implemented by a host device or its components as described herein. For example, the operations of method 900 may be performed by a host device as described with reference to FIGS. 1 through 6. In some examples, a host device may execute a set of instructions to control the functional elements of the device to perform the described functions. Additionally, or alternatively, the host device may perform aspects of the described functions using special-purpose hardware.

At 905, the method may include transmitting, to a memory device, a first message including a plurality of commands, where the first message includes a field indicating a type of the plurality of commands, and where each command of the plurality of commands is a memory device profile query command or a memory device provisioning command. In some examples, aspects of the operations of 905 may be performed by a transmission component 625 as described with reference to FIG. 6.

At 910, the method may include receiving, from the memory device, one or more second messages including information for each command of the plurality of commands based at least in part on transmitting the first message. In some examples, aspects of the operations of 910 may be performed by a reception component 630 as described with reference to FIG. 6.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transmitting, to a memory device, a first message including a plurality of commands, where the first message includes a field indicating a type of the plurality of commands, and where each command of the plurality of commands is a memory device profile query command or a memory device provisioning command and receiving, from the memory device, one or more second messages including information for each command of the plurality of commands based at least in part on transmitting the first message.

Aspect 2: The method, apparatus, or non-transitory computer-readable medium of aspect 1, further including operations, features, circuitry, logic, means, or instructions, or any combination thereof for receiving, from a boot loader, an indicator of a buffer including the plurality of commands, where transmitting the first message to the memory device is based at least in part on receiving the indicator from the boot loader.

Aspect 3: The method, apparatus, or non-transitory computer-readable medium of any of aspects 1 through 2, further including operations, features, circuitry, logic, means, or instructions, or any combination thereof for providing the information to a boot loader based at least in part on receiving the one or more second messages from the memory device.

Aspect 4: The method, apparatus, or non-transitory computer-readable medium of any of aspects 1 through 3, where the first message indicates for the memory device to access a respective portion of one or more memory arrays of the memory device for each command of the plurality of commands.

Aspect 5: The method, apparatus, or non-transitory computer-readable medium of any of aspects 1 through 4, where the first message is a single memory device command and the plurality of commands are included in an extra header segment portion of the single memory device command.

Aspect 6: The method, apparatus, or non-transitory computer-readable medium of any of aspects 1 through 5, further including operations, features, circuitry, logic, means, or instructions, or any combination thereof for transmitting, to the memory device, a third message including a plurality of second commands, where the third message includes the field indicating the type of the plurality of second commands, where each second command of the plurality of second commands is a read command or a write command and receiving, from the memory device, one or more fourth messages including data for each second command of the plurality of second commands based at least in part on transmitting the third message.

Aspect 7: The method, apparatus, or non-transitory computer-readable medium of any of aspects 1 through 6, where transmitting the first message including the plurality of commands is based at least in part on initiating a boot procedure of the memory device.

Aspect 8: The method, apparatus, or non-transitory computer-readable medium of any of aspects 1 through 7, where the information associated with each command includes query response information or interconnect response information.

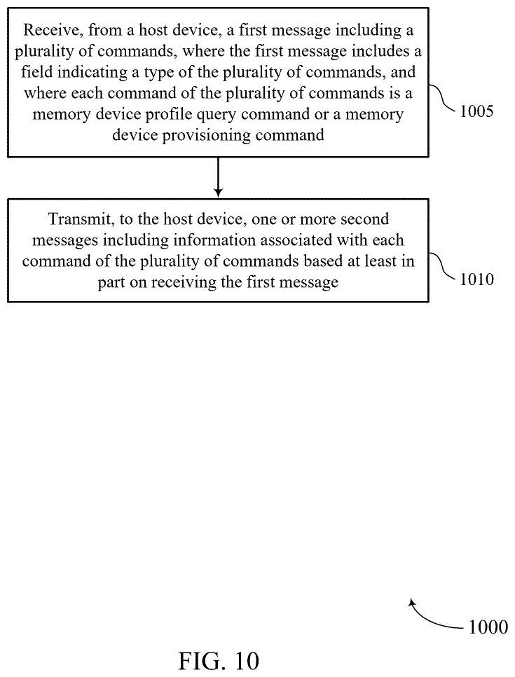

FIG. 10 shows a flowchart illustrating a method 1000 that supports unified command transmission for managed memory in accordance with examples as disclosed herein. The operations of method 1000 may be implemented by a memory device or its components as described herein. For example, the operations of method 1000 may be performed by a memory device as described with reference to FIGS. 1 through 5 and 7. In some examples, a memory device may execute a set of instructions to control the functional elements of the device to perform the described functions. Additionally, or alternatively, the memory device may perform aspects of the described functions using special-purpose hardware.

At 1005, the method may include receiving, from a host device, a first message including a plurality of commands, where the first message includes a field indicating a type of the plurality of commands, and where each command of the plurality of commands is a memory device profile query command or a memory device provisioning command. In some examples, aspects of the operations of 1005 may be performed by a reception component 725 as described with reference to FIG. 7.

At 1010, the method may include transmitting, to the host device, one or more second messages including information associated with each command of the plurality of commands based at least in part on receiving the first message. In some examples, aspects of the operations of 1010 may be performed by a transmission component 730 as described with reference to FIG. 7.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for receiving, from a host device, a first message including a plurality of commands, where the first message includes a field indicating a type of the plurality of commands, and where each command of the plurality of commands is a memory device profile query command or a memory device provisioning command and transmitting, to the host device, one or more second messages including information associated with each command of the plurality of commands based at least in part on receiving the first message.

Aspect 10: The method, apparatus, or non-transitory computer-readable medium of aspect 9, further including operations, features, circuitry, logic, means, or instructions, or any combination thereof for performing a plurality of operations corresponding to the plurality of commands based at least in part on receiving the first message, where transmitting the one or more second messages is based at least in part on performing the plurality of operations.

Aspect 11: The method, apparatus, or non-transitory computer-readable medium of aspect 10, where the information associated with each command includes query response information or interconnect response information.

Aspect 12: The method, apparatus, or non-transitory computer-readable medium of any of aspects 10 through 11, where performing the plurality of operations includes operations, features, circuitry, logic, means, or instructions, or any combination thereof for placing, based at least in part on receiving the first message, a single bundled command corresponding to the plurality of commands into a command queue for execution, the single bundled command corresponding to a single response to the host device.

Aspect 13: The method, apparatus, or non-transitory computer-readable medium of any of aspects 9 through 12, further including operations, features, circuitry, logic, means, or instructions, or any combination thereof for accessing a respective portion of one or more memory arrays of the memory device for each command of the plurality of commands, where transmitting the one or more second messages is based at least in part on accessing the respective portion of the one or more memory arrays for each command of the plurality of commands.

Aspect 14: The method, apparatus, or non-transitory computer-readable medium of aspect 13, where the information associated with each command includes data associated with accessing the respective portion of the one or more memory arrays for the respective command of the plurality of commands.

Aspect 15: The method, apparatus, or non-transitory computer-readable medium of any of aspects 9 through 14, where the first message is a single memory device command and the plurality of commands are included in an extra header segment portion of the single memory device command.

Aspect 16: The method, apparatus, or non-transitory computer-readable medium of any of aspects 9 through 15, further including operations, features, circuitry, logic, means, or instructions, or any combination thereof for receiving, from the host device, a third message including a plurality of second commands, where the third message includes the field indicating the type of the plurality of second commands, and where each second command of the plurality of second commands is a read command or a write command and transmitting, to the host device, one or more fourth messages including data associated with each second command of the plurality of second commands based at least in part on receiving the third message.

Aspect 17: The method, apparatus, or non-transitory computer-readable medium of aspect 16, further including operations, features, circuitry, logic, means, or instructions, or any combination thereof for accessing a respective portion of one or more memory arrays of the memory device for each second command of the plurality of second commands, where transmitting the one or more fourth messages is based at least in part on accessing the respective portion of the one or more memory arrays for each second command of the plurality of second commands.

Aspect 18: The method, apparatus, or non-transitory computer-readable medium of any of aspects 9 through 17, where receiving the first message including the plurality of commands is based at least in part on initiating a boot procedure of the memory device.

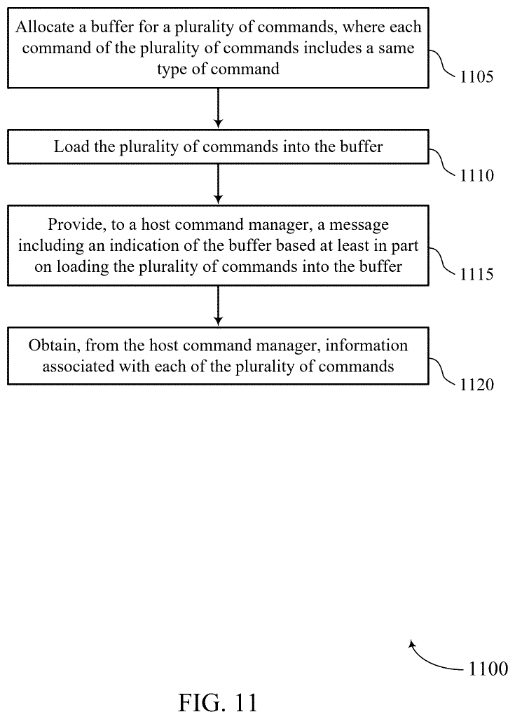

FIG. 11 shows a flowchart illustrating a method 1100 that supports unified command transmission for managed memory in accordance with examples as disclosed herein. The operations of method 1100 may be implemented by a bootloader or its components as described herein. For example, the operations of method 1100 may be performed by a bootloader as described with reference to FIGS. 1 through 5 and 8. In some examples, a bootloader may execute a set of instructions to control the functional elements of the device to perform the described functions. Additionally, or alternatively, the bootloader may perform aspects of the described functions using special-purpose hardware.

At 1105, the method may include allocating a buffer for a plurality of commands, where each command of the plurality of commands includes a same type of command. In some examples, aspects of the operations of 1105 may be performed by an allocation component 825 as described with reference to FIG. 8.

At 1110, the method may include loading the plurality of commands into the buffer. In some examples, aspects of the operations of 1110 may be performed by a load component 830 as described with reference to FIG. 8.

At 1115, the method may include providing, to a host command manager, a message including an indication of the buffer based at least in part on loading the plurality of commands into the buffer. In some examples, aspects of the operations of 1115 may be performed by a transmission component 835 as described with reference to FIG. 8.

At 1120, the method may include obtaining, from the host command manager, information associated with each of the plurality of commands. In some examples, aspects of the operations of 1120 may be performed by a reception component 840 as described with reference to FIG. 8.

In some examples, an apparatus as described herein may perform a method or methods, such as the method 1100. The apparatus may include features, circuitry, logic, means, or instructions (e.g., a non-transitory computer-readable medium storing instructions executable by a processor), or any combination thereof for performing the following aspects of the present disclosure:

Aspect 19: A method, apparatus, or non-transitory computer-readable medium including operations, features, circuitry, logic, means, or instructions, or any combination thereof for allocating a buffer for a plurality of commands, where each command of the plurality of commands includes a same type of command; loading the plurality of commands into the buffer; providing, to a host command manager, a message including an indication of the buffer based at least in part on loading the plurality of commands into the buffer; and obtaining, from the host command manager, information associated with each of the plurality of commands.

Aspect 20: The method, apparatus, or non-transitory computer-readable medium of aspect 19, further including operations, features, circuitry, logic, means, or instructions, or any combination thereof for identifying a plurality of operations associated with a boot procedure, where the plurality of commands correspond to the plurality of operations, where allocating the buffer for the plurality of commands is based at least in part on identifying the plurality of operations.

Aspect 21: The method, apparatus, or non-transitory computer-readable medium of any of aspects 19 through 20, further including operations, features, circuitry, logic, means, or instructions, or any combination thereof for identifying a power level change associated with a boot procedure, where allocating the buffer for the plurality of commands is based at least in part on identifying the power level change associated with the boot procedure.

Aspect 22: The method, apparatus, or non-transitory computer-readable medium of any of aspects 19 through 21, further including operations, features, circuitry, logic, means, or instructions, or any combination thereof for identifying a quantity of commands of the plurality of commands and identifying a size of the buffer based at least in part on identifying the quantity of commands, where allocating the buffer for the plurality of commands is based at least in part on identifying the size of the buffer.

Aspect 23: The method, apparatus, or non-transitory computer-readable medium of any of aspects 19 through 22, where the type of command includes a memory device profile query command or a memory device provisioning command.

Aspect 24: The method, apparatus, or non-transitory computer-readable medium of any of aspects 19 through 23, where the type of command includes a read command or a write command.

Aspect 25: The method, apparatus, or non-transitory computer-readable medium of any of aspects 19 through 24, where the message includes a field indicating the type of command of the plurality of commands.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A host device, comprising:
processing circuitry associated with one or more memory devices and configured to cause the host device to:
transmit, to a memory device, a first message comprising a plurality of commands, wherein the first message comprises a field indicating a type of the plurality of commands, and wherein each command of the plurality of commands is a memory device profile query command or a memory device provisioning command; and
receive, from the memory device, one or more second messages comprising information for each command of the plurality of commands based at least in part on transmitting the first message.

2. The host device of claim 1, wherein the processing circuitry is further configured to cause the host device to:
receive, from a boot loader, an indicator of a buffer comprising the plurality of commands,
wherein transmitting the first message to the memory device is based at least in part on receiving the indicator from the boot loader.

3. The host device of claim 1, wherein the processing circuitry is further configured to cause the host device to:
provide the information to a boot loader based at least in part on receiving the one or more second messages from the memory device.

4. The host device of claim 1, wherein the first message indicates for the memory device to access a respective portion of one or more memory arrays of the memory device for each command of the plurality of commands.

5. The host device of claim 1, wherein:
the first message is a single memory device command, and
the plurality of commands are included in an extra header segment portion of the single memory device command.

6. The host device of claim 1, wherein the processing circuitry is further configured to cause the host device to:
transmit, to the memory device, a third message comprising a plurality of second commands, wherein the third message comprises the field indicating the type of the plurality of second commands, wherein each second command of the plurality of second commands is a read command or a write command; and
receive, from the memory device, one or more fourth messages comprising data for each second command of the plurality of second commands based at least in part on transmitting the third message.

7. The host device of claim 1, wherein transmitting the first message comprising the plurality of commands is based at least in part on initiating a boot procedure of the memory device.

8. The host device of claim 1, wherein the information associated with each command comprises query response information or interconnect response information.

9. A memory device, comprising:
one or more memory arrays; and
processing circuitry coupled with the one or more memory arrays and configured to cause the memory device to:
receive, from a host device, a first message comprising a plurality of commands, wherein the first message comprises a field indicating a type of the plurality of commands, and wherein each command of the plurality of commands is a memory device profile query command or a memory device provisioning command; and
transmit, to the host device, one or more second messages comprising information associated with each command of the plurality of commands based at least in part on receiving the first message.

10. The memory device of claim 9, wherein the processing circuitry is further configured to cause the memory device to:
perform a plurality of operations corresponding to the plurality of commands based at least in part on receiving the first message,
wherein transmitting the one or more second messages is based at least in part on performing the plurality of operations.

11. The memory device of claim 10, wherein the information associated with each command comprises query response information or interconnect response information.

12. The memory device of claim 10, wherein performing the plurality of operations comprises the processing circuitry configured to cause the memory device to:
placing, based at least in part on receiving the first message, a single bundled command corresponding to the plurality of commands into a command queue for execution, the single bundled command corresponding to a single response to the host device.

13. The memory device of claim 9, wherein the processing circuitry is further configured to cause the memory device to:
access a respective portion of the one or more memory arrays of the memory device for each command of the plurality of commands,
wherein transmitting the one or more second messages is based at least in part on accessing the respective portion of the one or more memory arrays for each command of the plurality of commands.

14. The memory device of claim 13, wherein the information associated with each command comprises data associated with accessing the respective portion of the one or more memory arrays for the respective command of the plurality of commands.

15. The memory device of claim 9, wherein:
the first message is a single memory device command, and
the plurality of commands are included in an extra header segment portion of the single memory device command.

16. The memory device of claim 9, wherein the processing circuitry is further configured to cause the memory device to:
receive, from the host device, a third message comprising a plurality of second commands, wherein the third message comprises the field indicating the type of the plurality of second commands, and wherein each second command of the plurality of second commands is a read command or a write command; and
transmit, to the host device, one or more fourth messages comprising data associated with each second command of the plurality of second commands based at least in part on receiving the third message.

17. The memory device of claim 16, wherein the processing circuitry is further configured to cause the memory device to:
access a respective portion of the one or more memory arrays of the memory device for each second command of the plurality of second commands,
wherein transmitting the one or more fourth messages is based at least in part on accessing the respective portion of the one or more memory arrays for each second command of the plurality of second commands.

18. The memory device of claim 9, wherein receiving the first message comprising the plurality of commands is based at least in part on initiating a boot procedure of the memory device.

19. A method at a bootloader, comprising:
allocating a buffer for a plurality of commands, wherein each command of the plurality of commands comprises a same type of command;
loading the plurality of commands into the buffer;
providing, to a host command manager, a message comprising an indication of the buffer based at least in part on loading the plurality of commands into the buffer; and
obtaining, from the host command manager, information associated with each of the plurality of commands.

20. The method of claim 19, further comprising:
identifying a plurality of operations associated with a boot procedure, wherein the plurality of commands correspond to the plurality of operations,
wherein allocating the buffer for the plurality of commands is based at least in part on identifying the plurality of operations.

21. The method of claim 19, further comprising:
identifying a power level change associated with a boot procedure,
wherein allocating the buffer for the plurality of commands is based at least in part on identifying the power level change associated with the boot procedure.

22. The method of claim 19, further comprising:
identifying a quantity of commands of the plurality of commands; and
identifying a size of the buffer based at least in part on identifying the quantity of commands,
wherein allocating the buffer for the plurality of commands is based at least in part on identifying the size of the buffer.

23. The method of claim 19, wherein the type of command comprises a memory device profile query command or a memory device provisioning command.

24. The method of claim 19, wherein the type of command comprises a read command or a write command.

25. The method of claim 19, wherein the message comprises a field indicating the type of command of the plurality of commands.
